(19) United States
(12) Patent Application Publication
(10) Pub. No.: US 2025/0392330 A1
(43) Pub. Date: Dec. 25, 2025

(54) HIGH-FREQUENCY SWITCHING DEVICE

(71) Applicant: NRLAB Co., Ltd., Gyeonggi-do (KR)

(72) Inventors: Yoo Hwan KIM, Gyeonggi-do (KR); Ji Yu LEE, Seoul (KR)

(21) Appl. No.: 19/238,945

(22) Filed: Jun. 16, 2025

(30) Foreign Application Priority Data
Jun. 21, 2024 (KR) 10-2024-0080867
May 26, 2025 (KR) 10-2025-0068224

(51) Int. Cl. H04B 1/00; H01P 1/12; H04B 1/16

(52) U.S. Cl. CPC H04B 1/0078; H01P 1/122; H04B 1/1615

(57) ABSTRACT

Provided is a high-frequency switching device that conducts or blocks a signal transmission path between an antenna connection port, which is connected to an antenna to transmit and receive high-frequency signals, and an input/output port configured to input and output high-frequency signals. The high-frequency switching device includes a plurality of switch modules. Each of the plurality of switch modules includes a series switch and a shunt switch and has a T-type switch connection structure in which the shunt switch is branched from a node of the series switch. An impedance element for maintaining the antenna at a predetermined impedance is connected between the shunt switch and the ground terminal.

### CROSS-REFERENCE TO RELATED APPLICATIONS

This application claims priority to and the benefit of Korean Patent Application Nos. 10-2024-0080867 filed on Jun. 21, 2024 and 10-2025-0068224 filed on May 26, 2025, the disclosure of which is incorporated herein by reference in its entirety.

### FIELD

The present disclosure relates to a high-frequency switching device capable of achieving chip miniaturization while improving insertion loss.

### BACKGROUND

FIGS. 1 and 2 are circuit diagrams of a conventional high-frequency switching device.

Referring to FIGS. 1 and 2, an additional impedance switch 10 is provided separately from the switch of the TRX port in actual use to maintain the antenna at a predetermined impedance (e.g., 50 ohms). The requirements for the additional impedance switch 10 may vary depending on the carrier. The impedance switch 10 serves to prevent the generation of unwanted harmonics caused by external signals.

However, the additional impedance switch remains off during normal operation, and when the TRx port is active, additional unnecessary Coff is introduced, resulting in performance degradation. In addition, the additional impedance switch 10 increases the chip size, leading to a rise in IC cost.

### SUMMARY

The present disclosure provides a high-frequency switching device that prevents degradation in transmission and reception performance while achieving chip miniaturization.

In one aspect of the present disclosure, there is provided a high-frequency switching device that conducts or blocks a signal transmission path between an antenna connection port, which is connected to an antenna to transmit and receive high-frequency signals, and an input/output port configured to input and output high-frequency signals. The high-frequency switching device includes a plurality of switch modules. Each of the plurality of switch modules includes a series switch and a shunt switch and has a T-type switch connection structure in which the shunt switch is branched from a node of the series switch. An impedance element for maintaining the antenna at a predetermined impedance is connected between the shunt switch and the ground terminal.

The impedance element may include at least one of a resistive element and a resistor network.

In a state where two of shunt switches are connected in parallel, an impedance element is connected between one of the shunt switches and a ground terminal.

### BRIEF DESCRIPTION OF THE DRAWINGS

FIGS. 1 and 2 are circuit diagrams of a conventional high-frequency switching device.

FIG. 3 is a circuit diagram of one embodiment illustrating a high-frequency switching device according to the present disclosure.

FIG. 4 is a circuit diagram illustrating a resistor network.

FIG. 5 is a circuit diagram illustrating another embodiment of a high-frequency switching device according to the present disclosure.

FIG. 6 shows yet another embodiment illustrating a switch module having a shunt switch with a different configuration.

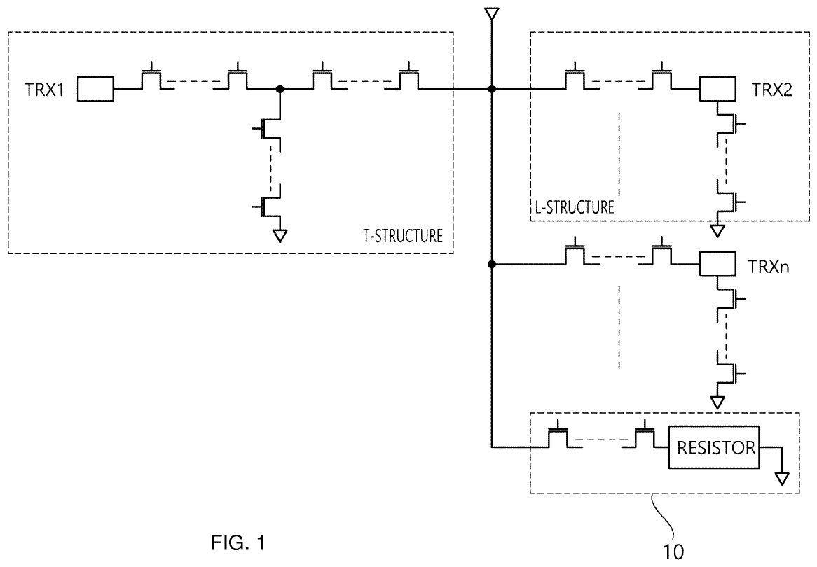

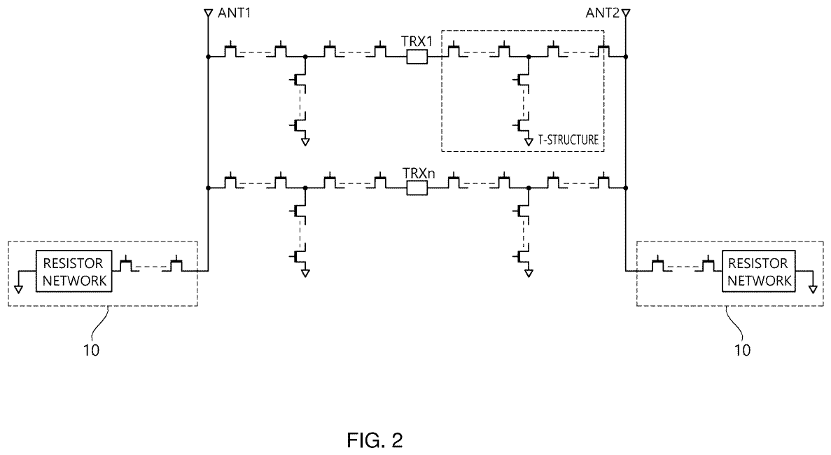

### DETAILED DESCRIPTION

Hereinafter, embodiments of the present disclosure will be described in detail with reference to the accompanying drawings.

The embodiments of the present disclosure are provided to offer a more complete understanding of the present disclosure to those skilled in the art. The following embodiments may be modified in various forms, and the scope of the present disclosure is not limited to these embodiments. Rather, these embodiments are provided to more fully convey the spirit of the present disclosure to those skilled in the art and to make this disclosure more complete.

The terminology used herein is for the purpose of describing particular embodiments only and is not intended to limit the invention. As used herein, the singular form may include the plural form unless the context clearly indicates otherwise. As used herein, the term “and/or” includes any and all combinations of one or more of the listed items.

The performance parameters of a switch are represented by Ron and Coff. The number of switch stacks and the size of each stack are determined according to the specifications of a high-frequency switching device. However, as the number of stacks increases, Ron deteriorates while Coff improves, indicating that Ron and Coff are in a trade-off relationship.

In addition, when the antenna and one or more TRx ports are turned on, the remaining TRx ports are turned off. The performance of a turned-on TRx port is inversely proportional to the number of turned-off TRx ports. That is, the performance of the turned-on TRx switch improves as the number of turned-off switches connected to the antenna decreases.

However, in addition to the TRx port in actual use, an additional switch is connected to present a predetermined impedance (e.g., 50 ohms) to the antenna.

The present disclosure provides a high-frequency switching device capable of preventing performance degradation by maintaining the antenna at a predetermined impedance (e.g., 50 ohms), thereby ensuring that high-order harmonics generated by external blocker signals remain below a system-specified level, while avoiding additional Coff during normal switch operation.

The high-frequency switching device may include both L-type and T-type switch connection structures, and a switch is designed in a T-type configuration to maximize isolation. In particular, to support multi-antenna structures and carrier aggregation (CA), the high-frequency switching device must include a T-type switch connection structure.

The present disclosure provides a switch structure in a high-frequency switching device including a T-type switch connection structure, which maintains a predetermined impedance (e.g., 50 ohms) at the antenna while preventing degradation in switch operation.

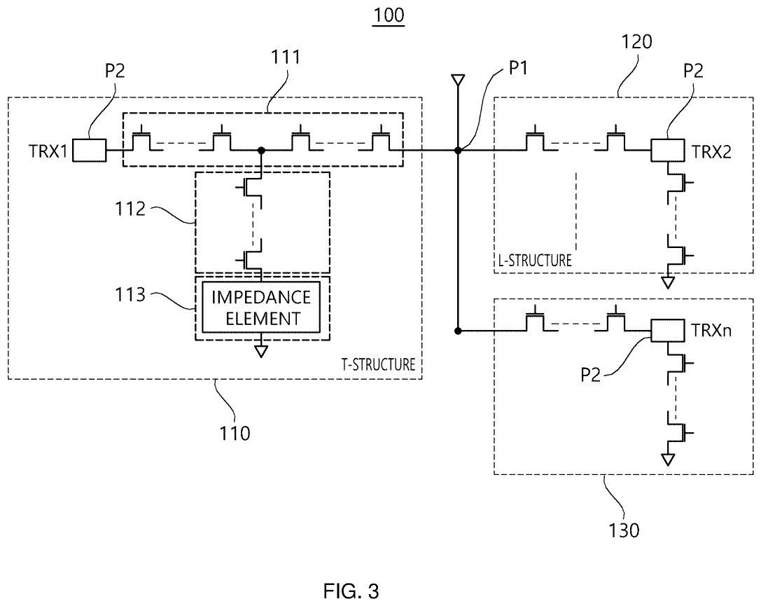

FIG. 3 is a circuit diagram illustrating one embodiment (first embodiment) of a high-frequency switching device 100 according to the present disclosure.

The high-frequency switching device 100 of FIG. 3 conducts or blocks a signal path between an antenna connection port P1, which is connected to an antenna to transmit and receive high-frequency signals, and input/output ports P2 for high-frequency signal transmission.

To this end, the high-frequency switching device 100 includes a plurality of switch modules.

Referring to FIG. 3, the high-frequency switching device 100 includes three switch modules. For example, a high-frequency switching device 100 may include a first switch module 110, a second switch module 120, and a third switch module 130. However, the number of switch modules included in the high-frequency switching device 100 may be increased or decreased as needed, and the number of switch modules illustrated in FIG. 3 is merely exemplary.

The first switch module 110 corresponds to a switch module having a T-type switch connection structure. The T-type switch connection structure is a structure in which a shunt switch is branched from one of the nodes connecting each switch element of the series switch.

To this end, the T-type first switch module 110 includes a series switch 111 and a shunt switch 112.

The series switch 111 includes a plurality of switch elements connected in series between the antenna connection port P1 and the input/output port P2. Here, the switching elements may include field effect transistors (FETs), bipolar junction transistors (BJTs), NMOS transistors (NM1 to NMn), and the like. However, these switching elements are only examples, and various other switching elements may be included.

The shunt switch 112 includes a plurality of switch elements connected in series between any one of the nodes connecting the switch elements included in the series switch 111 and a ground terminal.

In addition, the first switch module 110 includes an impedance element 113.

The impedance element 113 is connected between the shunt switch 112 included in the first switch module 110 and the ground terminal.

The impedance element 113 is an element for maintaining the antenna at a constant impedance (e.g., 50 [ohm]), and may be at least one of a resistive element and a resistor network.

When the impedance of the antenna is not set to a specific value (e.g., 50 ohms), external blocker signals may generate harmonic components to the outside, thereby distorting signals and interfering with communication.

To prevent this, the impedance element 113 is required. The impedance element 113 is configured to be turned off during TRX operation, and configured as a resistive element or a resistor network in combination with the switch stack.

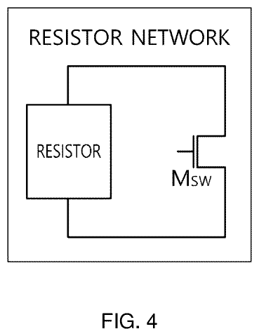

FIG. 4 is a reference diagram illustrating a resistor network.

As illustrated in FIG. 4, the resistor network includes a switch connected in parallel with a resistor, and one or more switch stacks may be provided depending on the application (the Rx or Tx maximum power specification).

The resistor network is an impedance element that provides a specific impedance (e.g., 50 ohms) by connecting a plurality of resistors in series or in parallel. By connecting the switch stack in parallel with the resistor network, the impedance element may be connected to the ground terminal.

Like the first switch module 110, each of the second switch module 120 and the third switch module 130 includes a series switch and a shunt switch. However, the second switch module 120 and the third switch module 130 have an L-type switch connection structure, in which the shunt switch is branched from the input/output port P2, and are thus structurally different from the first switch module 110 which has a T-type switch connection structure.

In addition, unlike the first switch module 110, the second switch module 120 and the third switch module 130 do not have an impedance element connected to the shunt switch but are connected to the ground terminal.

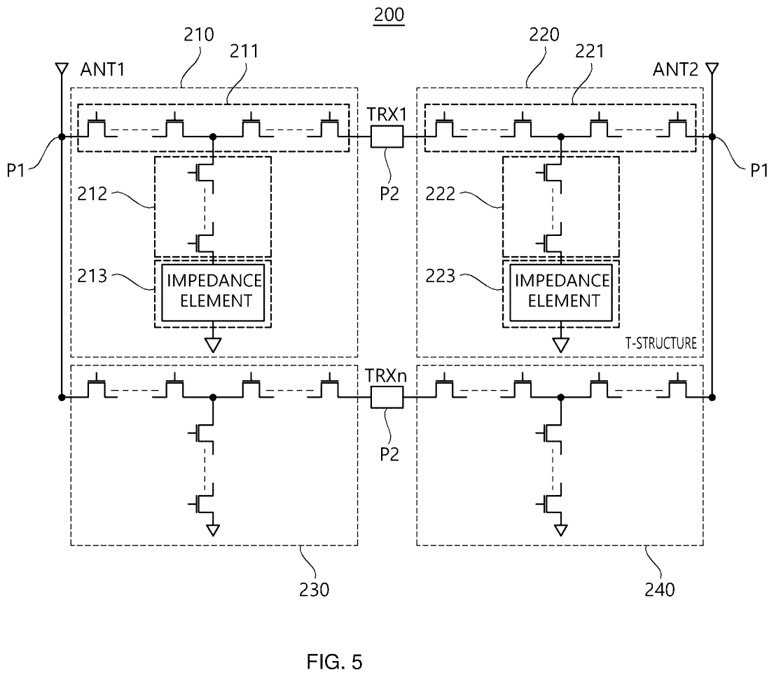

FIG. 5 is a circuit diagram illustrating another embodiment (second embodiment) of a high-frequency switching device 200 according to the present disclosure.

In the case of the high-frequency switching device 200 of FIG. 5, it also includes a plurality of switch modules.

Referring to FIG. 5, the high-frequency switching device 200 includes four switch modules. For example, a high-frequency switching device 200 may include a first switch module 210, a second switch module 220, a third switch module 230, and a fourth switch module 240. However, the number of switch modules included in the high-frequency switching device 200 may be increased or decreased as needed, and the number of switch modules illustrated in FIG. 5 is only exemplary.

The first switch module 210 corresponds to a switch module having a T-type switch connection structure. To this end, the first switch module 210 of type T includes a series switch 211 and a shunt switch 212.

The series switch 211 includes a plurality of switch elements connected in series between the antenna connection port P1 and the input/output port P2. Here, the switching elements may also include field effect transistors (FETs), bipolar junction transistors (BJTs), NMOS transistors (NM1 to NMn), and the like. However, these switching elements are only examples, and various other switching elements may be included.

The shunt switch 212 includes a plurality of switch elements connected in series between any one of the nodes connecting the switch elements included in the series switch 211 and the ground terminal.

In addition, the first switch module 210 includes an impedance element 213.

The impedance element 213 is connected between the shunt switch 212 included in the first switch module 210 and the ground terminal.

The impedance element 213 is used to maintain the antenna at a predetermined impedance (e.g., 50 ohms), and may be at least one of a resistive element and a resistor network.

The second switch module 220 is also a switch module having a T-type switch connection structure. To this end, the second switch module 220 includes a series switch 221 and a shunt switch 222. In addition, the second switch module 220 also includes an impedance element 223.

The features of the series switch 221, shunt switch 222, and impedance element 223 are the same as those of the series switch 211, shunt switch 212, and impedance element 213 described above, so a detailed description is omitted.

Like the first switch module 210 and the second switch module 220, the third switch module 230 and the fourth switch module 240 are also configured as switch modules having a T-type switch connection structure. To this end, each of the third switch module 230 and the fourth switch module 240 includes a series switch and a shunt switch.

However, unlike the first switch module 210 and the second switch module 220, the third switch module 230 and the fourth switch module 240 do not have an impedance element connected between the shunt switch and the ground terminal.

Meanwhile, in the aforementioned FIG. 5, it is illustrated that the impedance elements are connected only to the first switch module 210 and the second switch module 220 among the four switch modules, but this is merely an example.

Accordingly, it is also possible to configure the high-frequency switching device 200 such that impedance elements are connected to the third and fourth switch modules 230 and 240, while not connected to the first and second switch modules 210 and 220. In addition, an impedance element may be connected to only one of the four switch modules, or individual impedance elements may be connected to three or more of the switch modules.

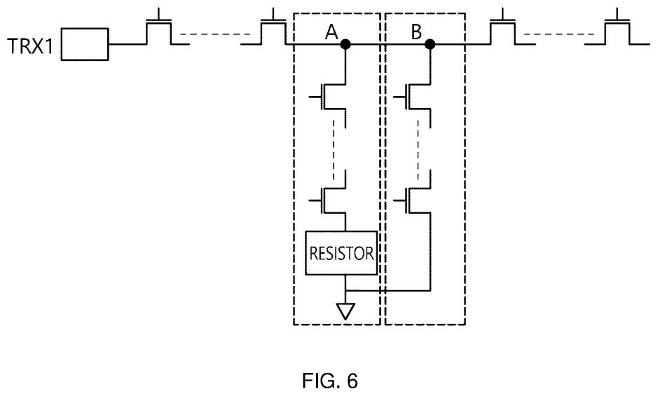

FIG. 6 shows yet another embodiment (third embodiment) of a switch module having a shunt switch with a different configuration in a T-type switch connection structure.

Referring to FIG. 6, two shunt switches are connected in parallel, forming two shunt paths: path A and path B. An impedance element is connected between the shunt switch corresponding to path A and the ground terminal.

In FIG. 6, path A is used to maintain the antenna at a predetermined impedance (e.g., 50 ohms), while path B is turned on to maximize isolation in the actual T-type switch connection structure.

As illustrated in FIGS. 3 to 6, in order to maintain the antenna at a constant impedance, an impedance element is connected between the shunt switch and the ground terminal in the T-type switch connection structure. This configuration prevents Coff from being added even during normal TRx port operation, thereby preventing performance degradation during high-frequency signal switching and enabling a reduction in the size of the high-frequency switching device.

Table 1 below compares the RF performance and chip size of the conventional method and the present disclosure.

TABLE 1

| | | Conventional | First | Conventional | Second | Third |
|---|---|---|---|---|---|---|
| | Frequency | Technology 1 | Embodiment | Technology 2 | Embodiment | Embodiment |
| Insertion | 960M | 0.26 | 0.25 | 0.43 | 0.42 | 0.42 |
| Loss | 1427M | 0.29 | 0.28 | 0.47 | 0.45 | 0.45 |
| | 2170M | 0.37 | 0.34 | 0.56 | 0.53 | 0.53 |
| | 2690M | 0.44 | 0.40 | 0.65 | 0.61 | 0.61 |
| | 3300M | 0.54 | 0.49 | 0.77 | 0.71 | 0.71 |
| | 4200M | 0.72 | 0.64 | 0.98 | 0.90 | 0.90 |
| | 5000M | 0.91 | 0.81 | 1.20 | 1.09 | 1.09 |
| Return | 960M | 22.25 | 22.86 | 21.20 | 21.72 | 21.72 |
| Loss | 1427M | 18.87 | 19.48 | 17.94 | 18.49 | 18.49 |
| | 2170M | 15.32 | 15.93 | 14.47 | 15.02 | 15.02 |
| | 2690M | 13.53 | 14.13 | 12.17 | 13.25 | 13.25 |
| | 3300M | 11.86 | 12.45 | 11.07 | 11.59 | 11.59 |
| | 4200M | 9.95 | 10.51 | 9.20 | 9.70 | 9.70 |
| | 5000M | 8.62 | 9.15 | 7.90 | 8.38 | 8.38 |
| Isolation | 960M | 60.93 | 60.92 | 96.85 | 96.84 | 96.84 |
| | 1427M | 57.53 | 57.51 | 90.03 | 90.01 | 90.01 |
| | 2170M | 53.97 | 53.95 | 82.87 | 82.84 | 82.84 |
| | 2690M | 52.18 | 52.14 | 79.23 | 79.19 | 79.19 |
| | 3300M | 50.50 | 50.45 | 75.82 | 75.77 | 75.77 |
| | 4200M | 48.59 | 48.51 | 71.87 | 71.79 | 71.80 |
| | 5000M | 47.26 | 47.16 | 60.09 | 68.98 | 68.99 |

As shown in Table 1, the first embodiment achieves an improvement in insertion loss of more than 0.1 dB at 5 GHz and a reduction in chip size compared to Conventional Technology 1. Similarly, when comparing Conventional Technology 2 with the second and third embodiments, improvements in insertion loss of more than 0.11 dB at 5 GHz and reductions in chip size are also observed.

According to the present disclosure, it is possible to implement a high-frequency switching device that satisfies radiation specifications even in response to external signals, reduces degradation in TRx performance, and enables chip miniaturization.

In a high-frequency switching device with a T-type switch connection structure, a resistive element for maintaining the antenna at a predetermined impedance (e.g., 50 ohms) is connected between the shunt switch and the ground terminal, instead of using an impedance switch directly connected to the antenna, thereby allowing the antenna to maintain the impedance even when an external blocker signal is applied.

Accordingly, according to the present disclosure, high-order harmonic signals may be reduced to levels below the system requirements, and performance degradation may be prevented by ensuring that Coff is not added during switch operation.

In addition, by placing a resistive element between the shunt switch and the ground terminal, the number of IC components required to configure an impedance switch may be minimized, thereby reducing both the manufacturing cost and size of the high-frequency switching device.

Although exemplary embodiments of the present disclosure have been described above, they are not intended to limit the scope of the present disclosure. The scope of the present disclosure should be interpreted based on the following claims, and all equivalent modifications and variations should be construed as falling within the scope of the present disclosure.

What is claimed is:

1. A high-frequency switching device that conducts or blocks a signal transmission path between an antenna connection port, which is connected to an antenna to transmit and receive high-frequency signals, and an input/output port configured to input and output high-frequency signals,
wherein the high-frequency switching device comprises a plurality of switch modules,
wherein each of the plurality of switch modules comprises a series switch and a shunt switch and has a T-type switch connection structure in which the shunt switch is branched from a node of the series switch, and
wherein an impedance element for maintaining the antenna at a predetermined impedance is connected between the shunt switch and the ground terminal.

2. The high-frequency switching device of claim 1, wherein the impedance element comprises at least one of a resistive element and a resistor network.

3. The high-frequency switching device of claim 1, wherein, in a state where two of shunt switches are connected in parallel, an impedance element is connected between one of the shunt switches and a ground terminal.
